(19) United States
(12) Patent Application Publication
(10) Pub. No.: US 2005/0276944 A1
(43) Pub. Date: Dec. 15, 2005

(54) Composite articles and methods of making the same

(76) Inventors: Mark M. Muggli, West St. Paul, MN (US); Katherine A.S. Graham, Roseville, MN (US); Kevin J. Doyle, Woodbury, MN (US); Maria P. Dillon, St. Paul, MN (US); Todd R. Williams, Lake Elmo, MN (US)

Correspondence Address: 3M INNOVATIVE PROPERTIES COMPANY, PO BOX 33427, ST. PAUL, MN, 55133-3427, US

(21) Appl. No.: 10/863,943

(22) Filed: Jun. 9, 2004

(51) Int. Cl. B32B 1/08

(52) U.S. Cl. 428/36.91; 428/119

(57) ABSTRACT

Composite articles having two different interlocked layers comprising thermoplastic, and methods for making the same.

### BACKGROUND

Composite articles such as films and tubing are widely used in industry. For those composite articles such as films that have two layers of different polymeric materials bonded to each other, achieving a sufficient degree of adhesion between the layers to prevent delamination during storage and/or use is a source of constant concern. Delamination is an especially troublesome problem if the two polymeric materials are dissimilar, for example, in the case where one polymeric material is a fluoropolymer and the other is a conventional non-fluorinated organic polymer.

Chemical methods have been used to enhance adhesion between different polymers. One conventional way for chemically enhancing adhesion between dissimilar polymers involves the use of a tie layer. A tie layer is generally a layer of material that exhibits levels of adhesion to both of the dissimilar polymeric materials that are greater than the level of adhesion between the dissimilar polymeric materials if directly bonded to each other.

Physical/chemical methods such as corona treatment have also been used to enhance adhesion between different polymeric materials.

In some cases, dissimilar thermoplastic materials have been mechanically interlocked by continuous interlocking ribs such as ribbed dovetail joints.

There remains a need for materials and methods that can increase adhesion between different polymeric materials.

### SUMMARY

In one aspect, the present invention provides a composite article comprising:
a first polymeric layer having first and second opposed major surfaces, the first polymeric layer having a base and a plurality of overhanging protrusions at predetermined locations on the base, the overhanging protrusions extending from the base, the base and protrusions defining the first major surface; and
a second polymeric layer having first and second opposed major surfaces and disposed on the first major surface of the first polymeric layer, wherein the first major surface of the second polymeric layer substantially conforms to the first major surface of the first polymeric layer and engages the overhanging protrusions, wherein the first and second polymeric layers are non-tacky, wherein the first and second polymeric layers have different compositions, and wherein if the protrusions comprise overhanging ribs at least a portion of the overhanging ribs intersect.

In another aspect, the present invention provides a method of making a composite article comprising:
a first polymeric layer having first and second opposed major surfaces, the first polymeric layer having a base and a plurality of overhanging protrusions at predetermined locations on the base, the overhanging protrusions extending from the base, the base and protrusions defining the first major surface; and
disposing a second polymeric layer having first and second opposed major surfaces on the first major surface of the first polymeric layer, wherein the first major surface of the second polymeric layer substantially conforms to the first major surface of the first polymeric layer and engages the overhanging protrusions, wherein the first and second polymeric layers are non-tacky, wherein the first and second polymeric layers have different compositions, and wherein if the protrusions comprise overhanging ribs at least a portion of the overhanging ribs intersect.

Composite articles of the present invention have mechanically interlocking features that typically enhance adhesion between different polymeric materials.

Composite articles according to the present invention can be designed so as to achieve a predetermined degree of adhesive anisotropy between the different polymeric materials, for example, the longitudinal and lateral adhesive strength may differ significantly or not at all.

As used herein, the phrases:

“overhanging protrusion” refers to any protrusion wherein at least one point exists within the protrusion from which the shortest line that can be drawn normal to the base is not wholly contained within the protrusion;
“substantially conforms to” means intimately contacts at least 75 percent of;
“substantially incompatible” means immiscible in the molten state; and
“fluoropolymer” means a polymer having at least 10 weight percent fluorine content.

### BRIEF DESCRIPTION OF THE DRAWING

FIG. 1 is a perspective cut-away view of an exemplary composite film of the present invention;

FIG. 2 is a perspective cut-away view of another exemplary composite film of the present invention;

FIG. 3 is a perspective cut-away view of an exemplary composite tube of the present invention; and

FIG. 4 is a cross-sectional photomicrograph of a composite film prepared in Example 2.

### DETAILED DESCRIPTION

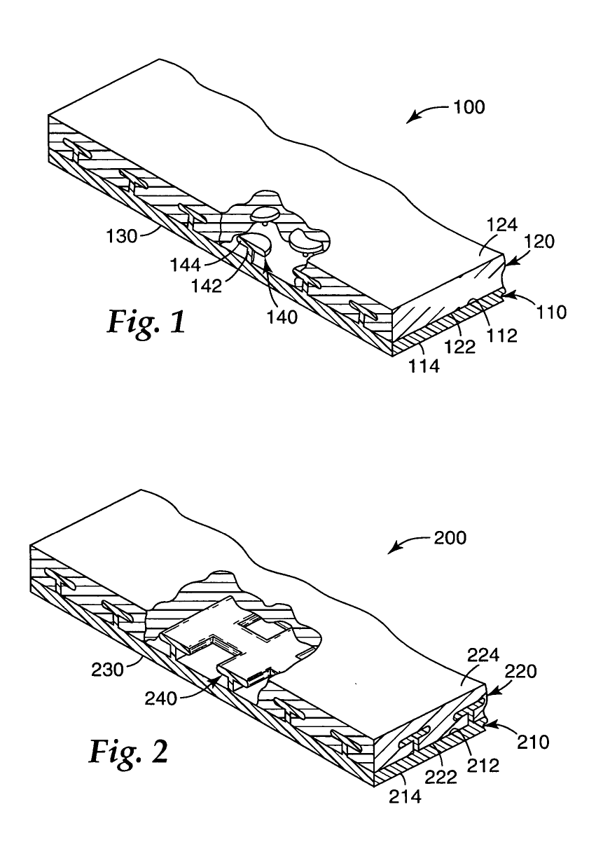

Composite articles of the present invention have at least two layers (i.e., first and second polymeric layers) interlocked by overhanging protrusions. The first and second polymeric layers are non-tacky (i.e., tack-free) at temperatures below 40° C. An exemplary composite article is shown in FIG. 1. Referring now to FIG. 1, composite film 100 has first polymeric layer 110 and second polymeric layer 120. First polymeric layer 110 has first and second opposed major surfaces 112 and 114, respectively. First major surface 112 contacts second polymeric layer 120. First polymeric layer 110 comprises base 130 and a plurality of capped stems 140 that extend from base 130. First major surface 112 is defined by base 130 and the plurality of capped stems 140. Capped stems 140 have stems 142 and caps 144.

Second polymeric layer 120 has first and second opposed major surfaces 122 and 124, respectively, and is disposed on first polymeric layer 110 such that first major surface 122 of second polymeric layer 120 substantially conforms to first major surface 112 of first polymeric layer 110 and engages capped stems 140. First and second polymeric layers 110, 120 comprise first and second polymeric materials, respectively, wherein the first and second polymeric materials are different.

Another exemplary composite article is shown in FIG. 2. Referring now to FIG. 2, composite film 200 has first polymeric layer 210 and second polymeric layer 220. First polymeric layer 210 has first and second opposed major surfaces 212 and 214, respectively. First major surface 212 contacts second polymeric layer 220. First polymeric layer 210 comprises base 230 and a plurality of intersecting overhanging ribs 240 that extend from base 230. First major surface 212 is defined by base 230 and the plurality of intersecting overhanging ribs 240.

Second polymeric layer 220 has first and second opposed major surfaces 222 and 224, respectively, and is disposed on first polymeric layer 210 such that first major surface 222 of second polymeric layer 220 substantially conforms to first major surface 212 of first polymeric layer 210 and engages overhanging ribs 240. First and second polymeric layers 210, 220 comprise first and second different polymeric materials.

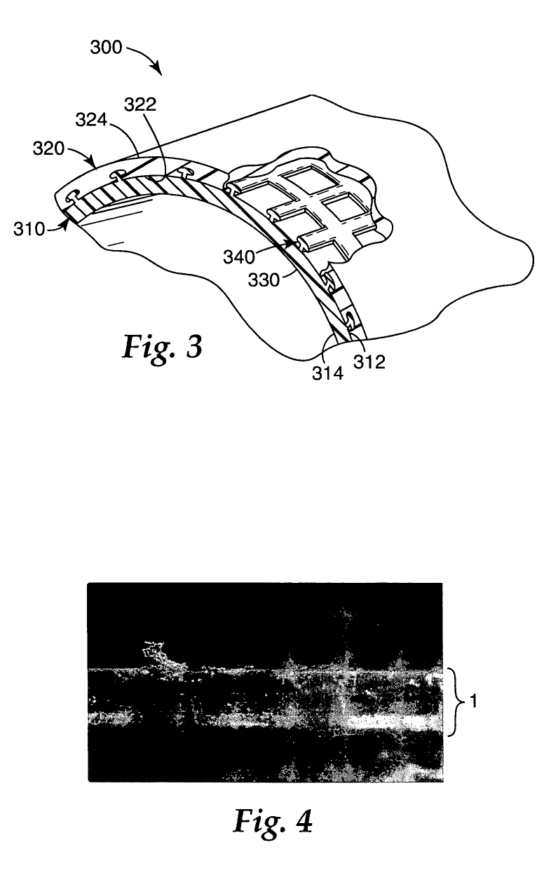

Another exemplary composite article is shown in FIG. 3. Referring now to FIG. 3, composite tube 300 has first polymeric layer 310 and second polymeric layer 320. First polymeric layer 310 has first and second opposed major surfaces 312 and 314, respectively. First major surface 312 contacts second polymeric layer 320. First polymeric layer 310 comprises base 330 and a plurality of intersecting overhanging ribs 340 that extend from base 330. First major surface 312 is defined by base 330 and the plurality of intersecting overhanging ribs 340.

Second polymeric layer 320 has first and second opposed major surfaces 322 and 324, respectively, and is disposed on first polymeric layer 310 such that first major surface 322 of second polymeric layer 320 substantially conforms to first major surface 312 of first polymeric layer 310 and engages overhanging ribs 340. First and second polymeric layers 310, 320 comprise first and second different polymeric materials.

Composite articles of the present invention may be used in applications in which attributes (e.g., cost, physical strength, and/or gas and/or liquid diffusion barrier properties) of the first and/or second polymeric layer are important. In such cases, the attribute(s) typically depends on the minimum thickness of the pertinent polymeric layer. Generally, in such cases, it is desirable that the overhanging protrusions have a small height in relation to the overall thickness of the composite article such that maximum and relatively uniform film thickness may be maintained. To achieve this result one or more protrusions, for example, substantially all of the protrusions, may have a height of less than or equal to about 0.5 millimeters, although some or all of the protrusions may be larger in some cases. Further, in those cases in which barrier properties of a polymeric material are relied upon, choosing that polymeric material for the first polymeric layer typically ensures that a minimum thickness is maintained.

The number of overhanging protrusions, may be relatively large. The number of ribs may be at least 2, 3, 5, 10, 30, 50, 100, 500, 1000 or even more, for example, as in the case of large area films, or the number of protrusions may be as few as two, for example, as in the case of very small composite articles.

The overhanging protrusions are positioned at predetermined locations on the base of the first polymeric layer, typically according to a recognizable pattern that may have one or more geometric elements such as triangular (e.g., three equidistant capped stems), rectangular, square (e.g., square overhanging ribs as shown for example in FIG. 2), hexagonal elements, or a combination thereof.

The overhanging protrusions may have any shape consistent with their definition hereinabove. For example, they may comprise arcuate filaments, continuous or segmented intersecting or non-intersecting ribs, capped stems or posts. The overhanging protrusions may generally flare out along their length from the base. The overhanging protrusions may have a stem portion of substantially constant diameter, optionally having a cap on the distal end thereof. The overhanging protrusions may be formed such that a portion of the overhanging protrusion is further from the base than the distal end. The overhanging protrusions may have smooth or uneven surfaces or may be present as a combination thereof. The protrusions may have any height, including mixtures of various heights. The overhanging protrusions may be combined with non-overhanging protrusions and/or depressions in the base in order to enhance the roughness of the first major surface of the first polymeric layer.

Composite articles according to the present invention may have a thickness of less than or equal to 1000 micrometers, 150 micrometers, 100 micrometers, 50 micrometers, or even less than or equal to 5 micrometers, although the thicknesses outside of this range are also useful.

In one embodiment, the first and second polymeric layers may have regions consisting of different, typically compatible, polymeric materials. For example, the first polymeric layer may have a base portion consisting of one polymeric material, and overhanging protrusions of another compatible polymeric material. Alternatively or in addition, the first and/or second polymeric layers may have regions of one polymeric material encased in a second polymeric material (e.g., as in the case of a semi-interpenetrating polymer network).

In some embodiments, it is generally desirable that some, most, or even all of the protrusions have a height with respect to a vertical line taken normal to the base, of less than 100 micrometers.

In some embodiments, the protrusions may have a height, with respect to a vertical line taken normal to the base, that is not more that about 20, 10, or even 5 percent of the minimum or maximum thickness of the composite article. This may particularly useful for those composite articles intended for use in applications wherein barrier properties of the composite article are important. By using protrusions with heights that are relatively small compared to the overall thickness of the composite article, it is typically possible to maintain a relatively thick layer of a given polymeric material, while simultaneously achieving benefits due to mechanical interlocking of the first and second polymeric layers of polymeric material.

The first major surface of the second polymeric layer contacts the first major surface of the first polymeric layer such that it at least substantially conforms to the first major surface of the first polymeric layer and engages the overhanging protrusions, thereby affixing the first and second polymeric layers to one another. The second polymeric layer at least substantially conforms (e.g., essentially completely) to the first major surface of the first polymeric layer, but deviations from conformance of the second polymeric layer may arise, for example, due to manufacturing tolerances, or by deliberate design.

The first and second polymeric layers may be of any relative thickness, for example, they may be of substantially equal average thickness, or they may be of unequal average thickness.

For many composite articles according to the present invention such as, for example, films and tubes, the second major surfaces of the first and second polymeric layers are typically smoother than the first major surface of the first polymeric layer.

The first and second polymeric layers comprise different polymeric materials, typically including at least one thermoplastic organic polymer in each layer. In some embodiments, the first and second polymeric materials may be at least substantially incompatible.

Although any polymeric material may be used in practice of the present invention, typically the first and second polymeric materials consists of thermoplastic material at some point during manufacture.

Any thermoplastic materials may be used in either layer of the composite articles of the present invention. Examples of suitable thermoplastic materials include polyamides and modified polyamides (e.g., nylon-6, nylon-6,6, nylon-11, nylon-6,12, nylon-6,9, nylon-4, nylon-4,2, nylon-4,6, nylon-7, nylon-8, and nylon-12), polyolefins (e.g., homopolymers of polyethylene or propylene), as well as copolymers of these monomers with acrylic monomers and other ethylenically unsaturated monomers such as vinyl acetate and higher alpha-olefins, polyesters, polycarbonates (e.g., polyestercarbonates, polyethercarbonates, and bisphenol A derived polycarbonates), polyurethanes (e.g., aliphatic, cycloaliphatic, aromatic, and polycyclic polyurethanes), polysiloxanes, poly(meth)acrylates (e.g., polymers of acrylic acid, methyl acrylate, ethyl acrylate, acrylamide, methacrylic acid, methyl methacrylate, and/or ethyl methacrylate), polyarylates, polyvinyls, polyethers, cellulosics, polyimides (e.g., polyimide polymers made from the anhydride of pyromellitic acid and 4,4′-diaminodiphenyl ether available from E.I. du Pont de Nemours and Company, Wilmington Del. under the trade designation “KAPTON”), fluoropolymers, polyketones, polyureas, thermoplastic elastomers (e.g., thermoplastic polyurethanes, styrene-butadiene copolymers, styrene-isoprene copolymers), and combinations thereof.

For many applications, including for example, those in which barrier properties are important, at least one of the first and second polymeric materials may comprise, on a total weight basis, at least 20, 30, 40, 50, 60, 70, 80, or 90 weight percent or even more of at least one fluoropolymer.

Useful fluoropolymers may be perfluorinated or only partially fluorinated. Useful fluoropolymers include, for example, those that are preparable (e.g., by free-radical polymerization) from monomers comprising chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example nitrile containing monomers (e.g., CF₂═CFO(CF₂) LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, CF₂═CFO(CF₂)ᵤOCF(CF₃)CN where L=2-12; q=0-4; r=1-2; y=0-6; t=1-4; and u=2-6), bromine containing monomers (e.g., Z-R_{f}—Oₓ—CF═CF₂, wherein Z is Br or I, R_{f} is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; terpolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro(alkyl vinyl ether) copolymers (e.g., tetrafluoroethylene-perfluoro(propyl vinyl ether)); and combinations of thereof.

Useful commercially available fluoropolymers include, for example, those marketed by Dyneon LLC under the trade designations “THV” (e.g., “THV 220”, “THV 400G”, “THV 500G”, “THV 815”, and “THV 610X”), “PVDF”, “PFA”, “HTE”, “ETFE”, and “FEP”; those marketed by Atochem North America, Philadelphia, Pa. under the trade designation “KYNAR” (e.g., “KYNAR 740”); those marketed by Ausimont, USA, Morristown, N.J. under the trade designations “HYLAR” (e.g., “HYLAR 700”) and “HALAR ECTFE”.

The first and second polymeric materials may optionally comprise one or more additional components such as, for example, stabilizers, antioxidants, pigments, plasticizers, UV absorbers, tackifiers, flow control agents, fillers, processing aids, adhesion promoters, colorants, glass bubbles, static control additives (e.g., carbon black), and/or thixotropes.

Composite articles according to the present invention can be made according to a variety of methods.

In one embodiment, the first polymeric layer may be created in a single-step process such as, for example, by profile extrusion, by embossing a polymer film, or by laminating a polymeric scrim (e.g., a polymeric scrim having features that form overhangs after lamination) to a polymeric film.

For example, the first polymeric layer may be created by bonding a thermoplastic scrim having intersecting ribs to a film or tubular base. In this method, the scrim may be, for example, of the same material of the base, or a different material that is bondable to the base, for example, by heating, or application of radiant or ultrasonic energy. The ribs may have overhanging features when bonded to the base, and/or they may be deformed to create overhanging ribs after attachment to the base, for example, by exposure to external energy (e.g., an air knife, infrared radiation, contact with a heated roll or platen). In another exemplary method, the first polymeric layer may be prepared in single step of casting molten polymer into a mold with undercut regions to create, upon removal from the mold, a layer having overhanging ribs on one surface.

In another embodiment, the first polymeric layer may be created in a multi-step process. For example, a polymeric film having an array of outwardly extending capped stems may be formed by extruding molten polymer into a tool having an array of cylindrical or frustoconical cavities, and then cooled while in contact with the tool. Separation of the cooled polymer film from the tool results in a film of polymer having an array of stems. The stems are subsequently calendered to produce a broader head at the top of the stems. Further details concerning such processes are described, for example, in U.S. Pat. No. 4,056,593 (de Navas Albareda); U.S. Pat. No. 4,290,174 (Kalleberg); U.S. Pat. No. 4,959,265 (Wood et al.); U.S. Pat. No. 5,077,870 (Melbye et al.); U.S. Pat. No. 5,679,302 (Miller et al.); U.S. Pat. No. 5,792,411 (Morris et al.); U.S. Pat. No. 6,039,911 (Miller et al.); and U.S. Pat. No. 6,190,594 (Gorman et al.); U.S. Pat. No. 6,372,323 (Kobe et al.); the disclosures of which are incorporated herein by reference.

In another exemplary method, the first polymeric layer may be created by embossing a film or casting molten polymer in a mold to create a layer having non-overhanging protrusions on one surface, followed by exposing the protrusion features to external energy (e.g., an air knife, infrared radiation, contact with a heated roll or platen) to form them into overhanging protrusions. For example, discontinuous ribs may be formed by extruding a layer of thermoplastic material having ribs, slitting the ribs cross-wise to their length, and stretching the layer along their length (e.g., using a wind up roll).

The second polymeric layer is then applied to the first major surface of the first polymeric layer. Useful methods for applying the second polymeric layer include, for example, solvent casting and extrusion.

Additional process steps such as, for example, calendering, embossing, stretching may also be used in combination with the above procedures.

Optionally, the composite article may be subjected to additional treatments that at least partially crosslink the first and/or second polymeric layers. Such treatments are well known and include, for example, heating, especially if the first and/or second polymeric layer further comprises a thermal crosslinking agent, and ultraviolet and/or electron beam radiation. Further details concerning crosslinking of polymeric materials may be found in, for example, U.S. Pat. No. 6,652,943 (Tukachinsky et al.) and PCT Patent Publication WO 200196487 A 1 (Suwa et al.).

Composite articles according to the present invention may have many useful forms including, for example, tubes (including hoses and pipes), blow molded articles (including bottles and bags), injection molded articles, and films (including sheets and rolls). Specific examples include fuel hoses, protective films, and fuel tank liners.

Tubular composite articles may be formed from composite sheets by bonding (e.g., using adhesive or a splice tape, or by annealing using heat or ultrasonic energy) opposing edges together.

Objects and advantages of this invention are further illustrated by the following non-limiting examples, but the particular materials and amounts thereof recited in these examples, as well as other conditions and, details, should not be construed to unduly limit this invention.

### EXAMPLES

All parts, percentages, ratios, etc. in the examples and the rest of the specification are by weight, unless noted otherwise. Unless otherwise noted, all reagents used in the examples were obtained, or are available, from general chemical suppliers such as, for example, Sigma-Aldrich Company, Saint Louis, Mo., or may be synthesized by conventional methods.

The following abbreviations are used throughout the examples: m=meter, cm=centimeter, mm=millimeter, min=minute, rpm=revolutions per minute, psi=pounds per square inch, and kPa=kiloPascals.

FILM A was made according to the following procedure. Polypropylene (available under the trade designation “C700-35N POLYPROPYLENE IMPACT COPOLYMER” from Dow Chemical Company, Midland, Mich.) was extruded from a 2.5-inch (6.4-cm) single screw extruder operating at 15 rpm and a temperature range ramping from 400 to 475° F. (204 to 246° C.) into the cavities of a mold maintained at 130° F. (54° C.) while moving a continuous surface of the mold, in which the cavities were recessed, at a speed of 33 feet/min (10 m/min). The mold had a square array of cavities, 0.68 mm apart in each direction along the surface of the mold (i.e. a density of 1400 cavities per square inch (217 cavities/cm²)). Each of the cavities was 0.26 mm in diameter and 1.4 mm deep. The resin was pressed into the cavities by a roller along the surface of the mold. The roller had a temperature of 90° F. (32° C.). The resin solidified in the mold and was stripped away from the mold as a web having an array of upstanding stems 300 micrometers long. Using a set of calendaring rolls, set at 90° F. (32° C.) and 280° F. (138° C.), the film was run through the nip between the rolls with a 7.8 mils (0.20 mm) gap at a speed of 25 feet/minute (7.6 m/min). Nominally, the resultant film had a base thickness of 5 mils (130 micrometers), feature height of 8 mils (200 micrometers), cap width of 15 mils (380 micrometers), a cap thickness of 2 mils (50 micrometers), and an overhang of 2.5 mils (65 micrometers).

Peel Strength Test

Peel strength measurements are determined as follows:

A 0.5-inch (1.3 cm) wide strip of sample (at least 1 inch (2.5 cm) in length) to be tested is prepared.

A crack (1.3 cm minimum length) is initiated between the layers between which peel adhesion is to be measured.

Each layer is placed in an opposed clamp of an Instron Tensile Tester (model 5564) obtained from Instron Corporation, Canton, Mass.

Peel strength was measured at a crosshead speed of 150 millimeters/minute as the average load for separation of to the two layers.

Reported peel strengths represent an average of at least two samples.

### Example 1

A thick layer (0.25-0.5 millimeters) of a two-component epoxy (available under the trade designation “SCOTCHWELD DP 100” from 3M Company was coated onto the capped side of Film A. After allowing the sample to cure at room temperature, the interlayer peel strength was measured.

### Comparative Example A

Example 1 was repeated except that the epoxy was coated on the flat side (instead of the capped side) of the film.

### Example 2

Example 1 was repeated except that the epoxy was replaced with a film (10 mils (250 micrometers) thickness) of ethylene-methyl methacrylate copolymer available under the trade designation “ACRYFT WK307” from Sumitomo Corporation of America, Houston, Tex. The copolymer film was applied to FILM A and placed in a Wabash heated hydraulic press (available from Wabash MPI, Wabash, Ind.) and heated at a temperature of 155° C. for 30 seconds without any applied pressure. Then a pressure of 300 psi (6.9 kPa) was applied with continued heating for 1.5 minutes, resulting in a composite film 1 shown in FIG. 4.

### Comparative Example B

The procedure of Example 2 was repeated except that the copolymer film was laminated to the side of FILM A that had no caps on it.

### Example 3

The capped side of FILM A was repeatedly flood coated with a solution of fluoropolymer (available under the trade designation “THV 220” from Dyneon, LLC). The solution was a 20 percent weight/weight solution of fluoropolymer in acetone. After each coating the solvent was removed. The coating procedure was repeated until a sufficient thickness of fluoropolymer was built up to cover the caps of FILM A. Then, the coated film was further processed by pressing under 300 psi (6.9 kPa) and at 135° C. for 0.5 minutes using a Wabash heated hydraulic press.

### Comparative Example C

The procedure of Example 2 was repeated except that the fluoropolymer film was coated onto the side of FILM A that had no caps on it.

TABLE 1

| | Peel Strength, |
|---|---|
| | Newtons/centimeter |
| Example 1 | ≧9, all samples broke in |
| | the polypropylene phase |
| Comparative | 0, all samples |
| Example A | spontaneously |
| | delaminated prior to |
| | testing |
| Example 2 | 4.4 |
| Comparative | 1.4 |
| Example B | |
| Example 3 | 2.0 |
| Comparative | 0 |
| Example C | |

Various modifications and alterations of this invention may be made by those skilled in the art without departing from the scope and spirit of this invention, and it should be understood that this invention is not to be unduly limited to the illustrative embodiments set forth herein.

1. A composite article comprising:
a first polymeric layer having first and second opposed major surfaces, the first polymeric layer having a base and a plurality of overhanging protrusions at predetermined locations on the base, the overhanging protrusions extending from the base, the base and protrusions defining the first major surface; and
a second polymeric layer having first and second opposed major surfaces and disposed on the first major surface of the first polymeric layer, wherein the first major surface of the second polymeric layer substantially conforms to the first major surface of the first polymeric layer and engages the overhanging protrusions, wherein the first and second polymeric layers are non-tacky, wherein the first and second polymeric layers have different compositions, and wherein if the protrusions comprise overhanging ribs at least a portion of the overhanging ribs intersect.

2. A composite article according to claim 1, wherein the composite article comprises at least one of a film or a tube.

3. A composite article according to claim 1, wherein the protrusions comprise at least one of overhanging intersecting ribs or capped stems.

4. A composite article according to claim 1, wherein the predetermined locations comprise a pattern having at least one triangular, rectangular, square, or hexagonal element.

5. A composite article according to claim 1, wherein the composite article has a maximum thickness, wherein no protrusion has a height, with respect to a vertical line taken normal to the base, that is greater than 20 percent of the maximum thickness of the composite article.

6. A composite article according to claim 1, wherein the composite article has a maximum thickness, wherein no protrusion has a height, with respect to a vertical line taken normal to the base, that is greater than 10 percent of the maximum thickness of the composite article.

7. A composite article according to claim 1, wherein the first and second polymeric materials are at least substantially incompatible.

8. A composite article according to claim 1, wherein at least one of first and second polymeric materials comprises at least one polyamide, polyolefin, polyester, polyimide, or a combination thereof.

9. A composite article according to claim 1, wherein at least one of the first and second polymeric materials comprises at least 20 weight percent of at least one fluoropolymer.

10. A composite article according to claim 10, wherein the fluoropolymer is preparable from monomers comprising chlorotrifluoroethylene, vinylidene difluoride, tetrafluoroethylene, hexafluoropropylene, perfluoro(methyl vinyl ether), perfluoro(propyl vinyl ether), vinyl fluoride, or a combination thereof.

11. A composite article according to claim 1, wherein one of the first and second polymeric materials comprises at least 20 weight percent of at least one fluoropolymer and the other polymeric material comprises at least one polyamide, polyolefin, polyester, polyimide, or a combination thereof.

12. A composite article according to claim 1, wherein the second major surfaces of the first and second polymeric layers are smoother than the first major surface of the first polymeric layer.

13. A composite article according to claim 14, wherein the composite article comprises a film.

14. A method of making a composite article comprising:
a first polymeric layer having first and second opposed major surfaces, the first polymeric layer having a base and a plurality of overhanging protrusions at predetermined locations on the base, the overhanging protrusions extending from the base, the base and protrusions defining the first major surface; and
disposing a second polymeric layer having first and second opposed major surfaces on the first major surface of the first polymeric layer, wherein the first major surface of the second polymeric layer substantially conforms to the first major surface of the first polymeric layer and engages the overhanging protrusions, wherein the first and second polymeric layers are non-tacky, wherein the first and second polymeric layers have different compositions, and wherein if the protrusions comprise overhanging ribs at least a portion of the overhanging ribs intersect.

15. A method according to claim 14, wherein the composite article comprises at least one of a film or a tube.

16. A method according to claim 14, wherein the protrusions comprise at least one of overhanging intersecting ribs or capped stems.

17. A method according to claim 14, wherein one of the first and second polymeric materials comprises at least 20 weight percent of at least one fluoropolymer.

18. A method according to claim 17, wherein the fluoropolymer is preparable from monomers comprising chlorotrifluoroethylene, vinylidene difluoride, tetrafluoroethylene, hexafluoropropylene, perfluoro(methyl vinyl ether), perfluoro(propyl vinyl ether), vinyl fluoride, or a combination thereof.

19. A method according to claim 14, wherein one of the first and second polymeric materials comprises at least one fluoropolymer and the other polymeric material comprises at least one polyamide, polyolefin, polyester, polyimide, or a combination thereof.

20. A method according to claim 14, wherein the second polymeric layer is extruded onto the first major surface of the first polymeric layer.
